(19) United States
(12) Patent Application Publication
(10) Pub. No.: US 2017/0133687 A1
(43) Pub. Date: May 11, 2017

(54) Electrode Material for an Electrochemical Storage System, Method for the Production of an Electrode Material and Elctrochemical Energy Storage System

(71) Applicant: Daimler AG, Stuttgart (DE)

(72) Inventor: Andreas HINTENNACH, Tamm (DE)

(73) Assignee: Daimler AG, Stuttgart (DE)

(21) Appl. No.: 15/317,692

(22) PCT Filed: May 19, 2015
(86) PCT No.: PCT/EP2015/001018

§ 371 Date: Dec. 9, 2016

(30) Foreign Application Priority Data
Jun. 12, 2014 (DE) 10 2014 008 739.5

(51) Int. Cl. H01M 4/66; H01M 4/58; B01J 19/12; H01M 4/40; C01B 33/029; H01M 10/0525; H01M 4/38

(52) U.S. Cl. CPC H01M 4/666; H01M 10/0525; H01M 4/5815; H01M 4/382; H01M 4/405; H01M 4/663; C01B 33/029; B01J 19/129; B01J 2219/0869; B01J 2219/0875; B01J 2219/1203; C01P 2004/13; C01P 2006/40

(57) ABSTRACT

An electrode material for an electrochemical storage system is disclosed. The electrode material being formed from a composite material, where the composite material includes at least one electrically conductive matrix and an active material. The electrically conductive matrix includes nanoscale, tubular structures made from silicon. A method for the production of an electrode material and an electrochemical energy storage system is also disclosed.

### BACKGROUND AND SUMMARY OF THE INVENTION

The invention relates to an electrode material for an electrochemical energy storage system. The invention furthermore relates to a method for the production of an electrode material and an electrochemical energy storage system.

An electrode material for lithium-ion batteries is known from DE 10 2004 016 766 A1, wherein the electrode material has 5-85% b.w. nanoscale silicon particles which have a BET surface of 5 to 700 m²/g and an average primary particle diameter of 5 to 200 nm. Furthermore, the electrode material has 0-10% b.w. conductive carbon black, 5-80% b.w. graphite having an average particle diameter of 1 μm to 100 μm and 5-25% b.w. of a binding agent, wherein the proportion of components have a maximum total of 100% b.w.

A method for the production of a carbon carrier having nanoscale silicon particles located on the surface and a carbon carrier having silicon particles with an average particle size of 1 nm to 20 nm located on the surface is furthermore known from DE 10 2011 008 815 A1. It is provided that, in the method, a silicon precursor and the carbon carrier are brought into contact with each other in an inert organic solvent, wherein the silicon precursor is decomposed by adding a reducing agent and/or by heating in pure silicon which is deposited on the carbon carrier.

The object of the invention is to specify an electrode material for an electrochemical energy storage system which is improved compared to the prior art, an improved method for the production of an electrode material and an improved electrochemical energy storage system.

An electrode material for an electrochemical storage system is formed from a composite material, wherein the composite material comprises at least one electrically conductive matrix and an active material. According to the invention, it is provided that the electrically conductive matrix comprises nanoscale, tubular structures made from silicon.

A mechanically stable electrode can be created by means of the electrode material formed in such a way, the stable electrode additionally having a high electrochemical performance. In particular, a high mechanical flexibility of the electrically conductive matrix can be achieved by means of the tubular structure of the silicon in the nanometer range, the flexibility being able to be significantly improved compared to the silicon structures known from the prior art. Volumetric changes of the electrode, which are induced during charging and discharging of the electrochemical storage system as a result of depositing and removing the active material, are therefore compensated for. As a result, the performance and lifespan of the electrochemical storage system can be improved considerably with respect to the prior art.

The active material is therefore bound to the nanoscale, tubular silicon structures in a chemically soluble manner, wherein chemically soluble here means the possibility of removing the active material when discharging the electrochemical storage system. Here, for example, lithium is oxidized into lithium ions and electrons as active material, wherein the lithium ions travel from the anode to the cathode. The composite material of the electrode material according to the invention is thus preferably formed as a coating material for an anode.

According to a preferred exemplary embodiment, the electrically conductive matrix also comprises a porous and mechanically flexible carbon structure, by means of which electrical conductivity of the electrode material is increased. Due to the mechanically flexible design of the carbon structure, compensation of the volumetric changes of the electrode can also be improved during charging and discharging.

A method according to the invention is provided for the production of the electrode material described above, the method comprising the following steps:

a) filling a first vessel with a predetermined amount of trichlorosilane;

b) arranging a section of a silicon wafer in a second vessel;

c) connecting the vessels with a pipe and sealing the pipe with a drop;

d) irradiating the trichlorosilane with electromagnetic radio-frequency radiation; and

e) removing a reaction product which is deposited on the section of the silicon wafer.

The trichlorosilane is heated by means of its irradiation according to step d), wherein the drop, for example, a glucose drop, melts within the pipe and the trichlorosilane flows into the second vessel in which the section of the silicon wafer is arranged. The reaction product is subsequently deposited on the section of the silicon wafer in the form of a coating by means of vapor deposition. The method enables the production of an electrode material which comprises nanoscale, tubular silicon structures in a simple and efficient manner.

In order to create the nanoscale, tubular silicon structures during vapor deposition, trichlorosilane is irradiated according to step d) with a continuously emitted, electromagnetic radio-frequency radiation. This is possible by means of a modified microwave oven which, compared to generally known microwave ovens, comprises a second high-voltage transformer and additionally two high-voltage capacitors and four high-voltage diodes. The continuously emitted radiation causes a continuous heating of the trichlorosilane such that, in particular, a nanoscale, tubular silicon structure can be produced.

The dimensions of the nanoscale, tubular silicon structures are thus dependent on the radiation power specified for the electromagnetic radio-frequency radiation. Controlled dimensions of the nanoscale, tubular silicon structures are thus possible.

Furthermore, the invention relates to an electrochemical energy storage system having at least one electrode, comprising an electrode material which is described above.

Exemplary embodiments of the invention are illustrated in greater detail below by means of drawings.

### BRIEF DESCRIPTION OF THE DRAWINGS

FIG. 1 schematically illustrates an exploded depiction of a single cell for a battery,

FIG. 2 schematically is a perspective view of a device for carrying out a method according to FIG. 2, and

FIG. 3 schematically illustrates an electrical circuit of power electronics of a microwave oven for the irradiation of an electrode material during the production of the electrode material.

### DETAILED DESCRIPTION OF THE DRAWINGS

Parts that correspond to one another are provided with the same reference numerals in all figures.

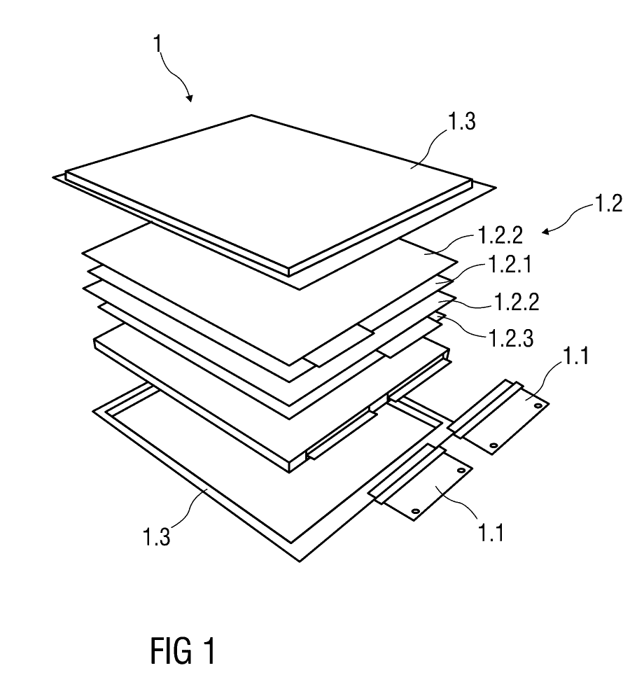

In FIG. 1, a single cell 1 for a battery which is not depicted in more detail is shown. In particular, the battery is a rechargeable battery, for example a lithium-sulphur battery.

The single cell 1 is a so-called pouch or coffee bag cell, wherein a number of such single cells 1 are connected electrically in series and/or in parallel with one another to form the battery and wherein interconnection takes place via plate-like arresters 1.1 as electrical connections of the single cell 1.

Such a single cell 1 is implemented as a flat and as rectangular as possible storage system element for electrical energy which comprises an electrode foil arrangement 1.2 made from layers of several alternately stacked, foil-like anodes 1.2.1, separators 1.2.2 and cathodes 1.2.3 which is surrounded by a foil-like casing 1.3 which is formed from two shell-like foil sections.

Here, the anode 1.2.1 is formed as a negative electrode and the cathode 1.2.3 is formed as a positive electrode. The anode 1.2.1 and the cathode 1.2.3 are referred to below as electrodes.

The electrodes of the single cell 1 are each formed from a substrate and are coated with an electrically conductive matrix in which an active material is contained in a defined manner. Here, the electrodes are formed as solid bodies, wherein the battery can preferably also be used for high temperature ranges and thus as a high-temperature battery.

The electrically conductive matrix for the cathode is, for example, formed from an electrically conductive carbon structure such as, for example, graphite or carbon black. The electrically conductive matrix for the anode 1.2.1 is formed from an electrically conductive carbon structure and a silicon structure since silicon has a less favorable level of electrical conductivity than carbon but can bind a larger quantity of active material.

The active material can be bound in the electrically conductive matrix homogeneously over the complete electrode. The active material serves for a chemical reaction taking place between the anode 1.2.1 and the cathode 1.2.3, in particular when charging and discharging the battery. If the battery is formed as a lithium-sulphur battery, then the active material is, for example, sulphur for the cathode 1.2.3 and lithium or a lithium alloy for the anode 1.2.1.

When discharging the battery, the lithium intercalated in the anode 1.2.1 is oxidized into lithium ions and electrons. The lithium ions travel through the ion-conducting separator 1.2.2 to the cathode 1.2.3, while at the same time the electrons are transferred via an outer circuit from the anode 1.2.1 to the cathode 1.2.3, wherein an energy consumer can be interconnected between the cathode 1.2.3 and the anode 1.2.1, the energy consumer being supplied with energy by the electron flow. At the cathode 1.2.3, the lithium ions are absorbed by a reduction reaction, wherein sulphur is reduced to lithium sulphide. The electrochemical reaction when discharging a battery is generally known and can, with the example of a lithium-sulphur battery, be described as follows:

Anode 1.2.1: Li→Li⁺+e⁻;

Cathode 1.2.3: S₈+2Li⁺+e⁻→Li₂S₈→Li₂S₆→Li₂S₄→Li₂S₂→Li₂S

When charging the battery, an energy source is connected to the electrodes. The lithium is thus oxidized from lithium sulphide to lithium cations, wherein the lithium cations travel via the separator 1.2.2 and the electrons via the outer circuit back to the anode 1.2.1.

The depositing of the active material, i.e., the lithium ions, for example, when charging the battery as well as the removal of the active material when discharging the battery lead to severe volumetric changes in the silicon structures known from the prior art, for example nanoscale, spherical silicon structures. This leads to very high mechanical loads of the electrode material, whereby premature failure of the electrode caused by a partial or full removal of the electrode material from the substrate is possible.

In order to solve the problem, the invention plans to use nanoscale, tubular silicon structures which are bound in the porous and mechanically flexible carbon structure.

A method according to the invention for the production of an electrode material is described below.

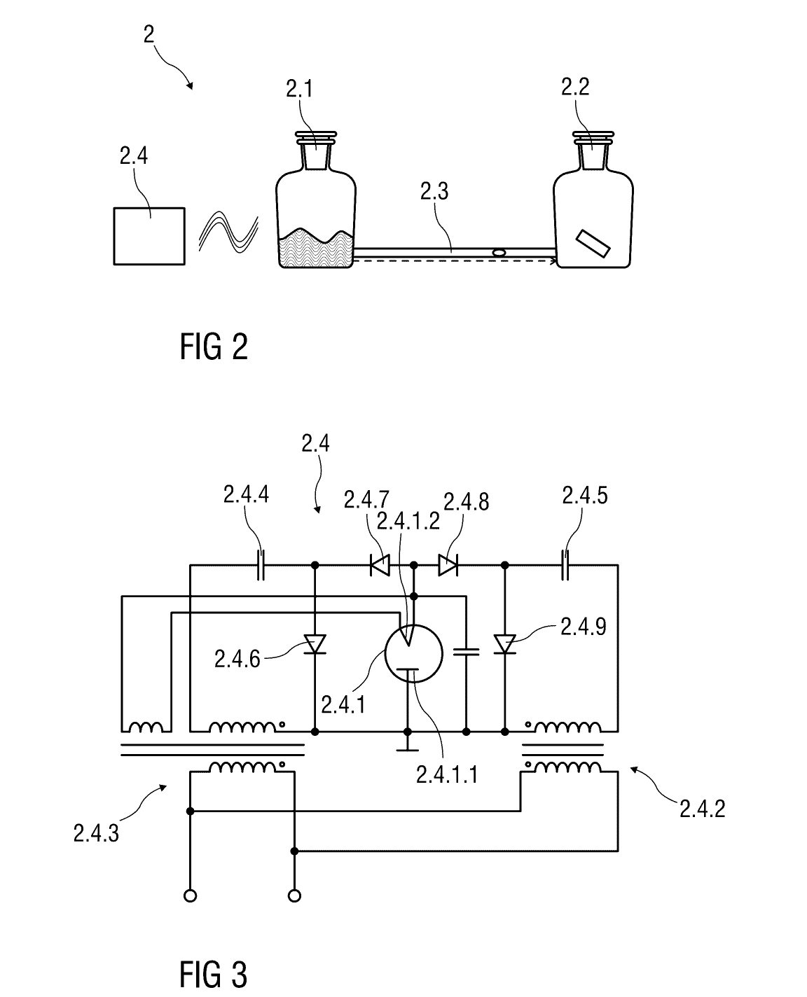

For this purpose, FIG. 2 shows a device 2 for carrying out the method.

The device 2 comprises two vessels 2.1, 2.2 having a predetermined capacity of, for example, 10 ml each. The vessels 2.1, 2.2 are both hermetically sealed by means of a sealing element in the form of a plug, for example a plug made from Teflon. In one exemplary embodiment, the vessels 2.1, 2.2 are each formed from an optically transparent material such as, for example, glass.

A first vessel 2.1 is filled with a determined amount, for example between 1.0 and 1.5 ml, of so-called trichlorosilane. Trichlorosilane is a product that is made from pure silicon which reacts with hydrogen chloride to form trichlorosilane.

A section of a silicon wafer is arranged in a second vessel 2.2.

The vessels 2.1, 2.2 are connected to each other by means of a pipe 2.3 which, for example, is formed from glass. A drop is arranged in an end region of the pipe 2.3 facing the second vessel 2.2, the drop being formed, for example, from glucose or from another saccharide. The drop thereby forms an artificial thrombosis and thus seals the pipe 2.3.

The device 2 furthermore comprises a microwave oven 2.4 which generates electromagnetic radio-frequency radiation, by means of which the trichlorosilane contained in the first vessel 2.1 is irradiated.

The electromagnetic radio-frequency radiation is emitted continuously, which is possible using corresponding power electronics of the microwave oven 2.4, which is described and depicted in more detail in FIG. 3.

The trichlorosilane is heated to a predetermined temperature by means of continuous irradiation of the trichlorosilane with electromagnetic radio-frequency radiation without a cooling of the trichlorosilane taking place, as is conceivable during pulsed irradiation. The pressure within the first vessel 2.1 also increases.

After a very short period of a few seconds, the drop melts in the pipe 2.3 such that, as a result of pressure equalization between the first vessel 2.1 and the second vessel 2.2, the heated trichlorosilane flows into the second vessel 2.2.

Here, the trichlorosilane reacts with the silicon wafer, wherein this is catalytically decomposed into silicon and further by-products such as, for example, hydrogen chloride, and is deposited as a reaction product on the silicon wafer. The reaction product is thus deposited on the silicon wafer as a coating. With progressing irradiation of the trichlorosilane, the reaction product changes color accordingly, for example, the color of the coating becomes darker, from which an end of the reaction can be concluded.

The reaction product deposited on the silicon wafer is then cooled to a predetermined temperature and can be separated from the silicon wafer by means of a cutting tool. The desired nanoscale, tubular silicon structures are formed by means of catalytic decomposition of trichlorosilane and the depositing of the reaction product on the silicon wafer, the silicon structures being able to be used immediately without further purification processes for the production of the electrode material.

Dimensions of the nanoscale, tubular silicon structures can thus be influenced depending on the strength of the emitted electromagnetic radio-frequency radiation. For example, the nanoscale, tubular silicon structures are longer if the irradiation of the trichlorosilane is emitted with a lower power.

FIG. 3 shows an electrical circuit of the microwave oven 2.4 in the form of a circuit diagram, wherein the circuit diagram only shows a part of the electrical circuit of the microwave oven 2.4, in particular power electronics.

The microwave oven 2.4 comprises a magnetron 2.4.1 having a positively charged electrode 2.4.1.1 and a negatively charged electrode 2.4.1.2.

The positively charged electrode 2.4.1.1 is connected to a ground potential such that the negatively charged electrode 2.4.1.2 has a negative voltage with respect to the ground potential.

In order to operate the magnetron 2.4.1 which generates electromagnetic high-frequency waves, the magnetron 2.4.1 is coupled to two high-voltage transformers 2.4.2, 2.4.3 which each increase an alternating voltage, in particular mains voltage, applied to a first coil, to a predetermined level in a second coil, in particular to a level in the high-voltage range.

The alternating high voltages generated in this way are each divided, rectified and applied to the negatively charged electrode 2.4.1.2 of the magnetron 2.4.1 by means of a high-voltage capacitor 2.4.4, 2.4.5 and a bridge rectifier circuit, each comprising two high-voltage diodes 2.4.6 to 2.4.9 connected in parallel to each other.

The rectified high voltages applied to the negatively charged electrode 2.4.1.2 thus each alternate periodically with a predetermined frequency between zero volts and a predetermined high voltage for operating the magnetron 2.4.1. A predetermined threshold voltage is thus allocated to the magnetron 2.4.1. If the high voltage applied to the magnetron 2.4.1 is greater than the threshold voltage, then a current flows through the magnetron 2.4.1 for a short period.

The microwave oven 2.4 described here is characterised in particular by a second high-voltage transformer 2.4.3 of the two high-voltage capacitors 2.4.4, 2.4.5 and the bridge rectifier circuit, whereby continuously emitted radio-frequency radiation is possible. For this purpose, the high voltages applied to the magnetron 2.4.1 exceed the threshold voltage alternately such that a current flows through the magnetron 2.4.1 continuously.

A cooling of the trichlorosilane, such as is conceivable in the case of pulsed irradiation, is prevented to the greatest extent possible by means of the continuous irradiation of the trichlorosilane. An optimal depositing of the reaction product on the silicon wafer and thus the formation of the nanoscale, tubular silicon structures are enabled as a result.

1.-8. (canceled)

9. An electrode material for an electrochemical storage system, comprising:
a composite material, wherein the composite material comprises an electrically conductive matrix and an active material;
wherein the electrically conductive matrix comprises nanoscale, tubular structures made from silicon.

10. The electrode material according to claim 9, wherein the active material is bound in a chemically soluble manner to the nanoscale, tubular structures.

11. The electrode material according to claim 9, wherein the composite material is a coating material for an anode.

12. The electrode material according to claim 9, wherein the electrically conductive matrix comprises a porous and mechanically flexible carbon structure.

13. A method for production of an electrode material according to claim 9, comprising the steps of:
a) filling a first vessel with a predetermined amount of trichlorosilane;
b) arranging a section of a silicon wafer in a second vessel;
c) connecting the first vessel and the second vessel with a pipe and sealing the pipe with a drop;
d) irradiating the trichlorosilane with electromagnetic radio-frequency radiation; and
e) removing a reaction product which is deposited on the section of the silicon wafer.

14. The method according to claim 13, wherein the trichlorosilane is irradiated with continuously emitted electromagnetic radio-frequency radiation.

15. The method according to claim 13, wherein dimensions of the nanoscale, tubular structures are dependent on a radiation power specified for the electromagnetic radio-frequency radiation.

16. An electrochemical energy storage system, comprising at least one electrode having an electrode material according to claim 9.
